(19) United States
(12) Patent Application Publication
(10) Pub. No.: US 2017/0367146 A1
(43) Pub. Date: Dec. 21, 2017

(54) MOBILE COMMUNICATION SYSTEM

(71) Applicant: SoftBank Corp., Tokyo (JP)

(72) Inventors: Hiroki RYOKE, Tokyo (JP); Masahiko NANRI, Tokyo (JP); Yuichi HAYASHI, Tokyo (JP)

(21) Appl. No.: 15/021,933

(22) PCT Filed: Dec. 22, 2015
(86) PCT No.: PCT/JP2015/085802

§ 371 Date: Mar. 14, 2016

(30) Foreign Application Priority Data
Mar. 13, 2015 (JP) 2015-051496

(51) Int. Cl. H04W 88/04; H04W 72/08; H04W 16/26

(52) U.S. Cl. CPC H04W 88/04; H04W 72/085; H04W 16/26

(57) ABSTRACT

A mobile communication system 1 for relaying packet communication between a macro cell base station 10 and a mobile unit 30 includes a femto cell base station 20 in which first radio communication is executed with the macro cell base station and second radio communication is executed with the mobile unit, wherein at least one of first frequency used for the first radio communication and second frequency used for the second radio communication is automatically selected so as to make the first frequency and the second frequency different from each other. It is possible to realize a mobile communication system capable of: preventing interference between a backhaul frequency and an access frequency when activating the mobile unit; preventing interference with the access frequency also when changing backhaul after establishing a connection or when receiving an instruction to change the access frequency; and preventing a loop phenomenon to select the access frequency, which is transmitted by the mobile unit itself, as the backhaul.

### CROSS REFERENCE TO RELATED APPLICATION(S)

This application is a National Phase application under 35 U.S.C. §371 of PCT Application PCT/JP2015/085802, filed Dec. 22, 2015, which claims priority to Japanese Patent Application No. 2015-051496, filed Mar. 13, 2015, which are all hereby incorporated by reference.

### TECHNICAL FIELD

The present invention relates to a mobile communication system for relaying packet communication between a macro cell base station and a mobile unit(s).

### BACKGROUND ART

Communication using a conventional femto cell (FMC: Femto Cell) base station has provided communication services by using fixed lines such as a public phone network as a backhaul (BH: Backhaul) (for example, see PTL 1).

### CITATION LIST

### Patent Literature

PTL 1 Japanese Patent No. 5456874

### BRIEF SUMMARY

### Problems to be Solved by the Invention

However, when the fixed lines are used as the backhaul as in the technology described in PTL 1, there is a problem requiring time to lay the fixed lines as well as the running cost for the fixed lines. In order to solve the problem of the femto cell communication using these fixed lines, it is possible to utilize a radio means such as a macro cell (MCC: Macro Cell) base station as the backhaul. Furthermore, regarding the femto cell base station, an implementation technique that enables radiation of a radio signal selected from a plurality of frequencies is also being examined. Accordingly, flexible use of the femto cell base station is possible by using radio communication with a plurality of frequencies as the backhaul.

However, when radio communication is utilized as the backhaul and if a frequency used for backhaul radio (BH) (backhaul frequency) is identical to a frequency used for access radio (AC: Access Link) to be radiated by the femto cell base station to communicate with a mobile unit(s) (access frequency), these radios will interfere with each other. In order to prevent interference, it is necessary to control the backhaul frequency and the access frequency so that they will not become identical to each other; however, a heavy burden is required for management, for example, by manually changing the frequencies, using a management server, for each individual femto cell base station according to the installed location of the femto cell base station.

Furthermore, when a macro cell base station that provides backhaul radio at an optimum frequency is opened and a destination is to be changed after radiation of the access radio from the femto cell base station, it is also necessary to consider the interference between the backhaul radio to be changed and the access radio. Furthermore, it is also necessary to prevent the phenomenon of looping within its own system by mistakenly recognizing the access radio as the backhaul radio.

The present invention was devised in light of the above-described circumstances and it is an object of the invention to provide a mobile communication system capable of preventing interference between the backhaul radio and the access radio at the femto cell base station, preventing interference between the backhaul radio and the access radio also when changing the backhaul frequency after establishing a connection, and preventing the loop phenomenon which can occur by mistakenly recognizing the access radio as the backhaul radio.

### Means for Solving the Problems

In order to achieve the above-described object, a mobile communication system according to the present invention is a mobile communication system for relaying packet communication between a macro cell base station and a mobile unit, wherein the mobile communication system includes a femto cell base station including: a base station control unit that executes first radio communication with the macro cell base station; and a radio unit that executes second radio communication with the mobile unit, wherein at least one of first frequency used for the first radio communication and second frequency used for the second radio communication is automatically selected so as to make the first frequency and the second frequency different from each other.

The femto cell base station randomly selects a frequency so as to make the first frequency and the second frequency different from each other.

The femto cell base station can select a frequency according to a predefined combination of frequencies so as to make the first frequency and the second frequency different from each other.

Furthermore, the femto cell base station can select a frequency of weakest signal intensity around the femto cell base station so as to make the first frequency and the second frequency different from each other.

The femto cell base station can select a frequency of worst signal quality around the femto cell base station so as to make the first frequency and the second frequency different from each other.

The femto cell base station can select a frequency outside its range so as to make the first frequency and the second frequency different from each other.

The first frequency and the second frequency can be different frequencies within the same frequency band; and the femto cell base station can select a frequency which is adjacent to a previously selected frequency and is a different frequency within the same frequency band so as to make the first frequency and the second frequency different from each other.

The femto cell base station can be a separated base station in which the base station control unit and the radio unit are separated from each other, or an integrated base station in which the base station control unit and the radio unit are integrated with each other.

### Advantageous Effects of Invention

The mobile communication system according to the present invention can prevent interference between the backhaul radio and the access radio, also prevent interference between the backhaul radio and the access radio when changing the backhaul frequency after establishing a connection or when receiving an instruction to change the access frequency, and prevent the loop phenomenon which can occur from mistakenly recognizing the access radio as the backhaul radio.

### BRIEF DESCRIPTION OF THE DRAWINGS

FIG. 1 is a schematic diagram illustrating the configuration of a mobile communication system according to an embodiment of the present invention;

FIG. 2 is a diagram for explaining frequencies that can be selected for a mobile communication system according to each embodiment;

FIG. 3 is a diagram for explaining operation when changing an optimum backhaul frequency in the mobile communication system according to each embodiment;

FIG. 4 is a diagram for explaining operation when changing the access frequency in the mobile communication system according to each embodiment;

FIG. 5 is a diagram for explaining operation to prevent loops in the mobile communication system according to each embodiment;

FIG. 6 is a diagram for explaining predefined combinations of frequencies in the mobile communication system according to a second embodiment; and

FIG. 7 is a diagram for explaining selection of a different frequency in a frequency band of a wide bandwidth in a mobile communication system according to a sixth embodiment.

### DETAILED DESCRIPTION OF THE INVENTION

First to sixth embodiments of the present invention will be explained with reference to drawings. However, the embodiments explained below are just for illustration and are not intended to exclude applications of various variations or technologies which are not clearly specified below. In other words, the present invention can be implemented in various variations (for example, by combining respective examples) within the range not departing from the gist of the invention. Furthermore, in the following descriptions of the drawings, the same or similar reference numerals are assigned to the same or similar parts. The drawings are schematic and are not necessarily identical to, for example, the actual size or proportions. The drawings can sometimes contain parts whose size relationship or proportions differ between the drawings.

### First Embodiment

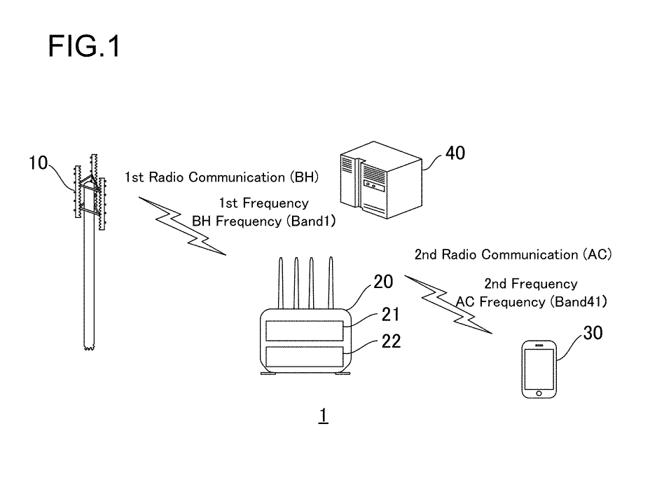

A mobile communication system according to a first embodiment of the present invention will be explained with reference to FIG. 1. FIG. 1 is a schematic diagram illustrating the configuration of the mobile communication system according to the first embodiment of the present invention.

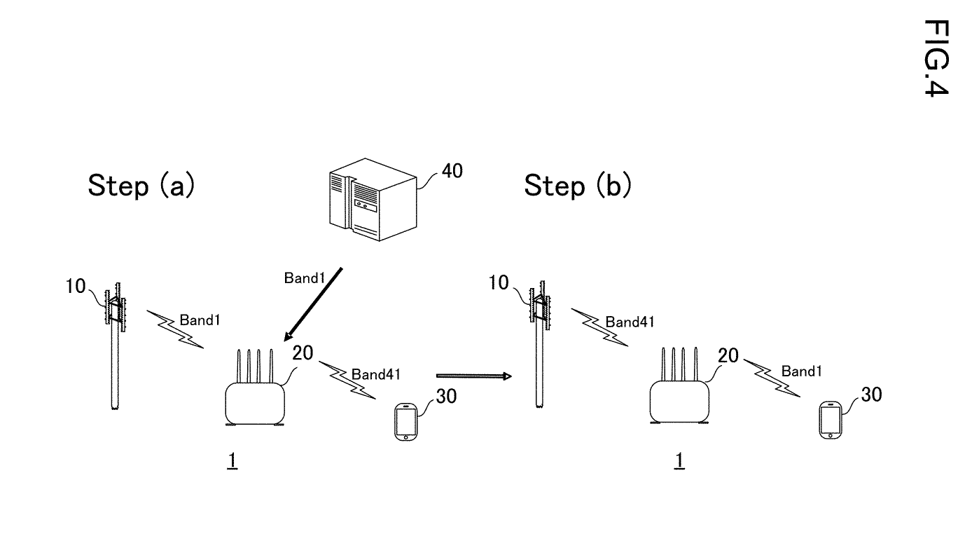

Referring to FIG. 1, a mobile communication system 1 according to the first embodiment includes a macro cell base station 10, a femto cell base station 20, a mobile unit 30, and a management server 40 (see FIG. 4). More specifically, the mobile communication system 1 according to the first embodiment is a system in which the femto cell base station 20 relays packet communication between the macro cell base station 10 and the mobile unit 30.

The macro cell base station 10 is called eNB (eNodeB) and constructs a communication area of, for example, a radius ranging from several hundreds of meters to a dozen kilometers or so by using radio access technology.

The femto cell base station 20 is called HeNB (Home eNodeB) and constitutes one of nodes in a, for example, LTE (Long Term Evolution) network. The femto cell base station 20 provides the mobile unit 30 with communication services (such as voice packet communication services and multimedia services) by using radio access technology similar to that of the macro cell base station 10. A cell formed by the femto cell base station 20 has a cell size smaller than that of the macro cell base station 10 and constructs a communication area of a radius ranging from several meters to several tens of meters. The femto cell base station 20 includes: a base station control unit 21 that executes first radio communication with the macro cell base station 10; and a radio unit 22 that executes second radio communication with the mobile unit 30 described later.

The mobile unit 30 is a mobile portable communication terminal such as a smartphone or a cell phone and is called UE (User Equipment).

The management server 40 is called HeMS (HeNB Management System) and manages the femto cell base station 20 with respect to each registered area. The management server 40 issues a change instruction to switch the access frequency between the femto cell base station 20 and the mobile unit 30.

First radio communication corresponding to backhaul radio is executed between the macro cell base station 10 and the femto cell base station 20. Furthermore, second radio communication corresponding to access radio is executed between the mobile unit 30 and the femto cell base station 20. The femto cell base station 20 selects at least one of the first frequency (the backhaul frequency) used for the first radio communication and the second frequency (the access frequency) used for the second radio communication so as to make the first frequency different from the second frequency.

When selecting at least one of the first frequency and the second frequency, the femto cell base station 20 according to the first embodiment randomly selects the frequency. The femto cell base station 20 according to this embodiment is equipped with a control program that performs interference control, control to change an optimum backhaul frequency, control to change the access frequency, and loop prevention control by randomly selecting at least one of the first frequency and the second frequency. More specifically, the femto cell base station 20 selects a frequency different from the backhaul frequency from among a plurality of selectable frequency bands and determines it as the access frequency.

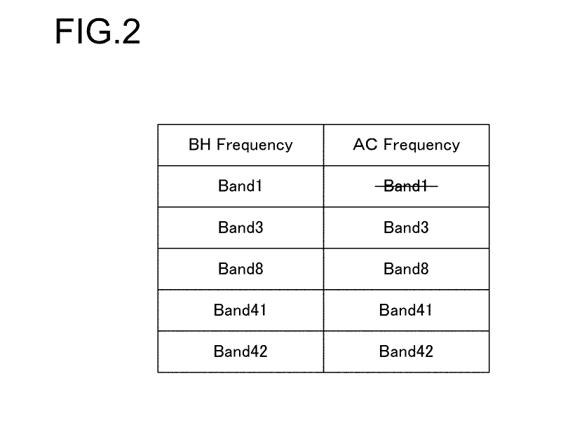

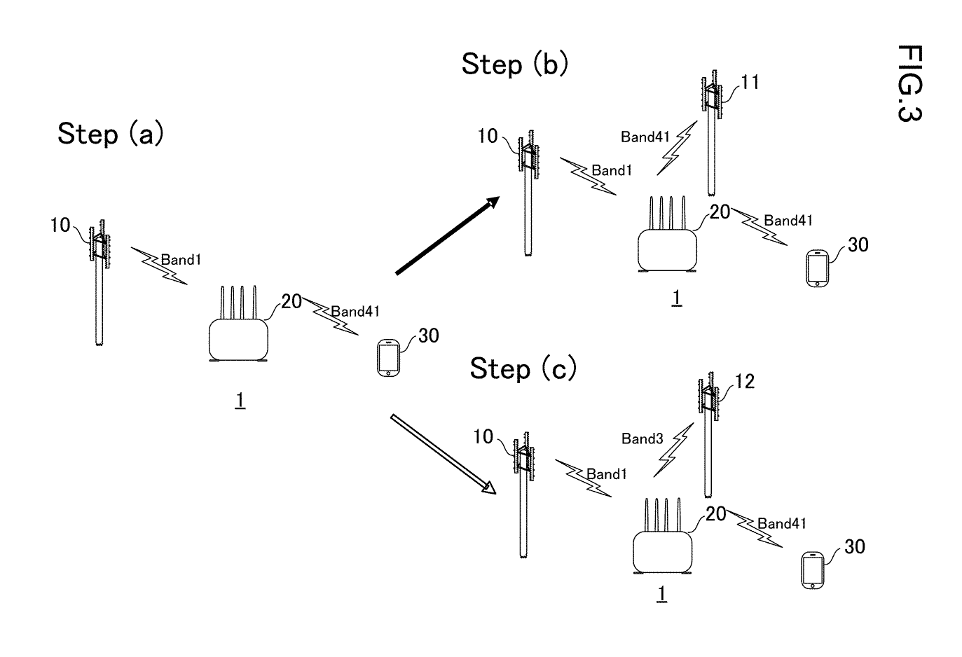

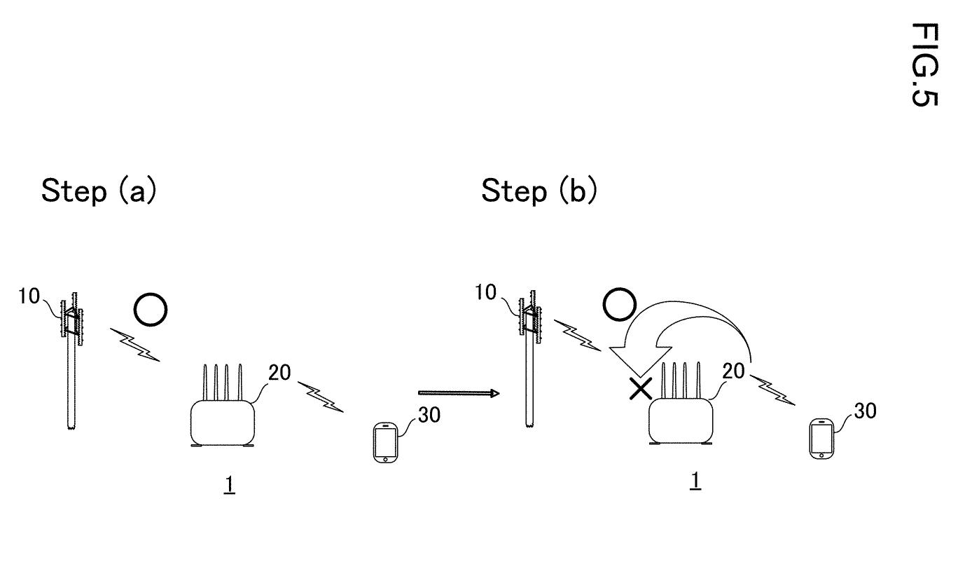

Next, the operation of the mobile communication system 1 according to the first embodiment will be explained with reference to FIG. 1 to FIG. 5. FIG. 2 is a diagram for explaining frequencies that can be selected for a mobile communication system according to each embodiment. FIG. 3 is a diagram for explaining operation when changing an optimum backhaul frequency in the mobile communication system according to each embodiment. FIG. 4 is a diagram for explaining operation when changing the access frequency in the mobile communication system according to each embodiment. FIG. 5 is a diagram for explaining operation to prevent loops in the mobile communication system according to each embodiment.

(Interference Control) When communicating with the mobile unit 30 as illustrated in FIG. 1, the femto cell base station 20 randomly selects a frequency so as to make the first frequency (the backhaul frequency) used for the first radio communication (BH) different from the second frequency (the access frequency) used for the second radio communication (AC), thereby preventing interference between the backhaul radio and the access radio. The interference control in the mobile communication system 1 according to the first embodiment will be hereinafter specifically explained.

In this description, an individual frequency is described as “Band X” (X is an arbitrary frequency number). “Band” is recognized as a “frequency band” according to its normal meaning as an English word; however, in this description, it is described as having the same meaning as a specific frequency. Regarding the practice in real society, a description like “Band X” includes a representative frequency of a frequency band to be used and a modulation method to be used, which are defined by a specified industry organization or regulating authorities. The frequency number can be, for example, EARFCN (E-UTRAN Absolute Radio Frequency Channel Number) according to the LTE standard.

The femto cell base station 20 firstly searches around the femto cell base station 20 at the time of start of connection with the mobile unit 30 and then selects backhaul (BH) radio capable of communication depending on its communication capability (Capability). After selecting the backhaul radio, the femto cell base station 20 checks the selected backhaul frequency, that is, the frequency band, frequency number, etc., of the backhaul radio.

Next, the femto cell base station 20 automatically randomly selects a frequency different from the selected backhaul frequency. For example, as illustrated in FIG. 1, when the femto cell base station 20 selects the backhaul radio with the macro cell base station 10 and then checks the backhaul frequency used for the selected backhaul radio, the backhaul frequency is Band 1. In this case, as illustrated in FIG. 2, Band 1 is excluded from selectable access frequency candidates and any one of the other frequencies, that is, Band 3, Band 8, Band 41, and Band 42, is automatically randomly selected as the access frequency. In FIG. 1, Band 41 is selected as the access frequency.

(Control To Change Optimum Backhaul Frequency) When an optimum macro cell base station is opened in the neighborhood, the femto cell base station 20 also randomly selects the frequency so as to make the first frequency (the backhaul frequency) used for the first radio communication (BH) different from the second frequency (the access frequency) used for the second radio communication (AC), thereby preventing interference between the backhaul radio and the access radio. Control to change the optimum backhaul frequency in the mobile communication system 1 according to the first embodiment will be specifically explained below.

For example, as illustrated in Step (a) of FIG. 3, when the femto cell base station 20 selects the backhaul radio with the macro cell base station 10 and then checks the frequency of the selected backhaul radio, the backhaul frequency is Band 1. Furthermore, the femto cell base station 20 removes Band 1 from the candidates for the access frequency and automatically randomly selects the frequency Band 41, which is different from the backhaul frequency, as the access frequency (see FIG. 2).

As an example, the macro cell base station 11 whose backhaul frequency is Band 41 is opened in the neighborhood in this connection status as illustrated in Step (b) of FIG. 3. Even if the macro cell base station 11 with the frequency Band 41 is opened, the femto cell base station 20 and the mobile unit 30 perform access communication using the same frequency Band 41 as that of the opened macro cell base station 11, so that the femto cell base station 20 continues the connection with the macro cell base station 10 with the originally selected frequency Band 1 in order to prevent the backhaul frequency and the access frequency from becoming identical to each other.

Furthermore, as an example, a macro cell base station 12 whose backhaul frequency is Band 3 is opened in the neighborhood as illustrated in Step (c) of FIG. 3. This frequency Band 3 does not cause interference, unlike Band 41 which is the access frequency of the mobile unit 30. So, if the femto cell base station 20 determines that the backhaul radio of the frequency Band 3 is optimum, the femto cell base station 20 switches connection to the macro cell base station 12 with the frequency Band 3.

(Control To Change Access Frequency) When receiving a change instruction from the management server 40 to switch the access frequency with the mobile unit 30, the femto cell base station 20 also randomly selects the frequency so as to make the first frequency (the backhaul frequency) used for the first radio communication (BH) different from the second frequency (the access frequency) used for the second radio communication (AC), thereby preventing interference between the backhaul radio and the access radio. Control to change the access frequency in the mobile communication system 1 according to the first embodiment will be specifically explained below.

The management server 40 can issue the change instruction to the femto cell base station 20 to switch the access frequency as illustrated in FIG. 4. Even if the management server 40 issues the instruction to the femto cell base station 20 to switch the access frequency of the access radio to radiate, the femto cell base station 20 randomly selects a backhaul frequency which is different from the access frequency.

For example, when the management server 40 issues the change instruction to switch the access frequency of the femto cell base station 20 to Band 1 as illustrated in Step (a) of FIG. 4, the femto cell base station 20 compares the backhaul frequency with the access frequency for which the instruction to change the frequency has been issued. Then, the femto cell base station 20 switches the access frequency to Band 1 unless any problem such as interference between the backhaul frequency and the access frequency occurs as a result of the backhaul frequency becoming identical to the access frequency for which the change instruction was issued. On the other hand, if any problem such as interference between the backhaul frequency and the access frequency occurs as a result of the backhaul frequency becoming identical to the access frequency for which the change instruction was issued, the problem regarding the change instruction is reported to the management server 40. For example, the backhaul frequency is Band 1 as illustrated in Step (a) of FIG. 4. So, if the access frequency is switched to Band 1, the backhaul frequency becomes identical to the access frequency and interference occurs between these frequencies. Then, the femto cell base station 20 reports it to the management server 40 and has it change the backhaul frequency to the randomly selected Band 41 as illustrated in Step (b) of FIG. 4.

(Loop Prevention Control) The femto cell base station 20 selects the second frequency (the access frequency) used for the second radio communication (AC) so that the second frequency (the access frequency) will be different from the first frequency (the backhaul frequency) used for the first radio communication (BH), thereby preventing the loop phenomenon in which the access radio can be recognized as the backhaul radio. Control to change the access frequency in the mobile communication system 1 according to the first embodiment will be specifically explained below.

When activating the mobile unit 30 as illustrated in Step (a) of FIG. 5, the femto cell base station 20 selects the backhaul radio of the optimum macro cell base station 10, then checks the frequency of the selected backhaul radio, and automatically randomly selects the access frequency with the mobile unit 30 so as to make it a different frequency from this backhaul frequency. Therefore, it is possible to prevent the loop phenomenon in which the access radio can be mistakenly recognized as the backhaul radio.

Even after the activation of the mobile unit 30 as illustrated in Step (b) of FIG. 5, the femto cell base station 20 is prohibited from selecting the backhaul radio of the macro cell base station 10 which performs communication using the same backhaul frequency as the access frequency, thereby making it possible to prevent the occurrence of the loop phenomenon.

When the femto cell base station 20 for the mobile communication system 1 according to the first embodiment as explained above selects at least one of the first frequency (the backhaul frequency) and the second frequency (the access frequency), it randomly selects the frequency so as to make these frequencies different from each other. Therefore, when the mobile communication system 1 according to the first embodiment is employed, it is possible to prevent interference between the backhaul radio and the access radio when connecting to the mobile unit 30 and also prevent interference between the backhaul radio and the access radio when changing the backhaul frequency after establishing the connection or when receiving the instruction to change the access frequency. It is also possible to prevent the loop phenomenon of mistakenly recognizing the access radio as the backhaul radio by using the mobile communication system 1 according to the first embodiment.

Each of the macro cell base station 10 and the femto cell base station 20 can sometimes be assigned a unique identification number. For example, standards called ECGI (E-UTRAN Cell Global ID) and PCI (Physical Cell Identity) can be used for such identification numbers. The femto cell base station 20 to which the identification number is assigned stores a list of identification numbers to be excluded and not selected. So, it is possible to apply the idea of the present invention to this identification number. For example, when the identification number included in the backhaul radio or the access radio to be selected matches an identification number which is prohibited from being selected, the femto cell base station 20 can be operated to not select such backhaul radio or access radio, that is, to not switch the frequency.

### Second Embodiment

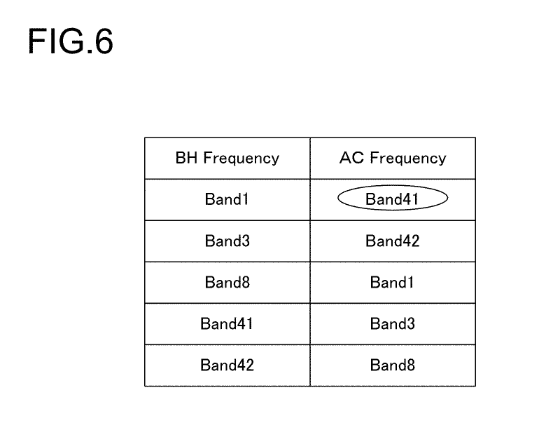

Next, a mobile communication system according to a second embodiment of the present invention will be explained with reference to FIG. 1 and FIG. 3 to FIG. 6. FIG. 6 is a diagram for explaining a predefined combination of frequencies in the mobile communication system according to the second embodiment. For clarity, the same components as those in the first embodiment are assigned the same reference numerals and have had their explanations omitted.

The difference between the mobile communication system according to the second embodiment and the first embodiment is that in the second embodiment, when the femto cell base station 20 selects at least one of the first frequency (the backhaul frequency) and the second frequency (the access frequency) after checking, for example, the frequency band and the frequency number (such as EARFCN) of the selected backhaul radio, it selects the frequency according to a predefined combination of frequencies.

More specifically, when the femto cell base station 20 according to the second embodiment selects at least one of the first frequency and the second frequency, it selects the frequency according to a predefined combination of frequencies as illustrated in FIG. 6. The femto cell base station 20 according to this embodiment is equipped with a control program that performs interference control, control to change the optimum backhaul frequency, control to change the access frequency, and loop prevention control by selecting the predefined combination of the first frequency and the second frequency.

(Interference Control) Referring to FIG. 1, the femto cell base station 20 selects the frequency according to the predefined combination of frequencies so as to make the first frequency (the backhaul frequency) used for the first radio communication (BH) different from the second frequency (the access frequency) used for the second radio communication (AC), thereby preventing interference between the backhaul radio and the access radio. The interference control in the mobile communication system according to the second embodiment will be specifically explained below.

The femto cell base station 20 firstly searches around the femto cell base station 20 and then selects a backhaul radio capable of communication depending on its communication capability. After selecting the backhaul radio, the femto cell base station 20 checks, for example, the frequency band and frequency number (such as EARFCN) of the selected backhaul radio.

Next, the femto cell base station 20 automatically selects the access frequency different from the selected backhaul frequency according to the predefined combination. For example, the femto cell base station 20 is equipped with a control program to select the frequency according to the predefined combination such as the backhaul frequency Band 1 and the access frequency Band 41, the backhaul frequency Band 3 and the access frequency Band 42, the backhaul frequency Band 8 and the access frequency Band 1, the backhaul frequency Band 41 and the access frequency Band 3, or the backhaul frequency Band 42 and the access frequency Band 8 as illustrated in FIG. 6. The femto cell base station 20

For example, as illustrated in FIG. 1, when the femto cell base station 20 selects the backhaul radio and then checks the frequency of the selected backhaul radio, the backhaul frequency is Band 1. In this case, as illustrated in FIG. 6, the frequency Band 41, which is predefined for Band 1, is automatically selected as the access frequency.

(Control To Change Optimum Backhaul Frequency) When an optimum macro cell base station 11 is opened in the neighborhood, the femto cell base station 20 also randomly selects the frequency according to the predefined combination of frequencies so as to make the first frequency (the backhaul frequency) used for the first radio communication (BH) different from the second frequency (the access frequency) used for the second radio communication (AC), thereby preventing interference between the backhaul radio and the access radio. Control to change the optimum backhaul frequency in the mobile communication system according to the second embodiment will be specifically explained below.

For example, as illustrated in Step (a) of FIG. 3, when the femto cell base station 20 selects the backhaul radio at the time of activation of the mobile unit 30 and then checks the frequency of the selected backhaul radio, the backhaul frequency is Band 1. Furthermore, the femto cell base station 20 selects the frequency Band 41 as the access frequency according to the predefined combination as illustrated in FIG. 6.

As an example, a macro cell base station 11 whose backhaul frequency is Band 41 is opened in the neighborhood in this connection status as illustrated in Step (b) of FIG. 3. Even if the macro cell base station 11 of the frequency Band 41 is opened, the femto cell base station 20 and the mobile unit 30 perform access communication using the same frequency Band 41 as that of the opened macro cell base station 11, so that the femto cell base station 20 continues the connection with the macro cell base station 10 with the originally selected frequency Band 1 in order to prevent the backhaul frequency and the access frequency from becoming identical to each other.

Furthermore, for example, a macro cell base station 12 whose backhaul frequency is Band 3 is opened in the neighborhood as illustrated in Step (c) of FIG. 3. If the femto cell base station 20 determines that the frequency Band 3 is optimum, the femto cell base station 20 switches connection to the macro cell base station 12 with the frequency Band 3 and also switches the access frequency to the frequency Band 42 according to the predefined combination.

It is possible to previously set a plurality of access frequencies which will not cause interference with one backhaul frequency. If the access frequency is switched during communication, the access communication with the mobile unit 30 is disconnected once; however, if the plurality of access frequencies are set for one backhaul frequency, it is possible to prevent the disconnection of the access communication. For example, Band 41 is also registered in advance, besides Band 42, as a selectable access frequency for Band 3, which is the backhaul frequency. In that case, even if the backhaul frequency is switched to Band 3, Band 41 can be used as the access frequency. So, when switching the backhaul frequency from Band 41 to Band 3, it is unnecessary to switch the access frequency and Band 41 can be used continuously. Therefore, it is possible to continuously use the same access frequency and prevent the disconnection of the access communication.

(Control To Change Access Frequency) When a change instruction to switch the access frequency with the mobile unit 30 is issued from the management server 40, the femto cell base station 20 selects the frequency according to the predefined combination so as to make the first frequency (the backhaul frequency) used for the first radio communication (BH) different from the second frequency (the access frequency) used for the second radio communication (AC), thereby preventing interference between the backhaul radio and the access radio. Control to change the access frequency in the mobile communication system according to the second embodiment will be specifically explained below.

The management server 40 can issue the change instruction to the femto cell base station 20 to switch the access frequency as illustrated in FIG. 4. When the management server 40 issues the instruction to the femto cell base station 20 to switch the access frequency, the femto cell base station 20 selects the backhaul frequency, which is different from the access frequency, according to the predefined combination.

For example, when the management server 40 issues the change instruction to switch the access frequency of the femto cell base station 20 from Band 41 to Band 1 as illustrated in Step (a) of FIG. 4, the femto cell base station 20 compares the backhaul frequency with the access frequency. Then, the femto cell base station 20 switches the access frequency to Band 1 unless any problem such as interference between the backhaul frequency and the access frequency occurs as a result of the backhaul frequency becoming identical to the access frequency. On the other hand, if any problem such as interference between the backhaul frequency and the access frequency occurs as a result of the backhaul frequency becoming identical to the access frequency regarding which the change instruction was issued, the problem regarding the change instruction is reported to the management server 40. For example, the backhaul frequency is Band 1 as illustrated in Step (a) of FIG. 4. So, if the access frequency is switched to Band 1, the backhaul frequency becomes identical to the access frequency and interference occurs between these frequencies. Then, the femto cell base station 20 reports it to the management server 40 and has it change the backhaul frequency to the frequency Band 8 according to the predefined combination as illustrated in FIG. 6.

(Loop Prevention Control) The femto cell base station 20 selects the second frequency (the access frequency) used for the second radio communication (AC) according to the predefined combination so that the second frequency (the access frequency) will be different from the first frequency (the backhaul frequency) used for the first radio communication (BH), thereby preventing the loop phenomenon in which the access radio can be mistakenly recognized as the backhaul radio. Control to change the access frequency in the mobile communication system according to the second embodiment will be specifically explained below.

When activating the mobile unit 30 as illustrated in Step (a) of FIG. 5, the femto cell base station 20 selects the backhaul radio of the macro cell base station 10, then checks the frequency of the selected backhaul radio, and selects the access frequency with the mobile unit 30 according to the predefined combination so as to make it a different frequency from this backhaul frequency. Therefore, it is possible to prevent the loop phenomenon in which the access radio can be mistakenly recognized as the backhaul radio.

Even after the activation of the mobile unit 30 as illustrated in Step (b) of FIG. 5, the femto cell base station 20 selects a different frequency according to the predefined combination to prohibit the backhaul radio of the macro cell base station 10, which performs communication using the same backhaul frequency as the access frequency, from being selected, thereby making it possible to prevent the occurrence of the loop phenomenon.

When the femto cell base station 20 for the mobile communication system according to the second embodiment as explained above selects at least one of the first frequency (the backhaul frequency) and the second frequency (the access frequency), it selects the frequency according to the predefined combination so as to make these frequencies different from each other. Therefore, when the mobile communication system according to the second embodiment is employed, it is possible to prevent interference between the backhaul radio and the access radio when starting the connection to the mobile unit 30 and also prevent interference between the backhaul radio and the access radio when changing the backhaul frequency after establishing the connection or when receiving the instruction to change the access frequency. It is also possible to prevent the loop phenomenon of mistakenly recognizing the access radio, which is to communicate with the mobile unit 30,as the backhaul radio by using the mobile communication system 1 according to the second embodiment. Particularly, when the mobile communication system according to the second embodiment is used, the femto cell base station 20 selects the frequency according to the predefined combination. So, it has the advantageous effect of easily selecting the frequency.

Each of the macro cell base station 10 and the femto cell base station 20 is assigned a unique identification number such as ECGI or PCI; and when the identification number included in the backhaul radio or the access radio to be selected matches a identification number which is prohibited from being selected, the femto cell base station 20 can be operated to not select such backhaul radio or access radio, that is, to not switch the frequency.

### Third Embodiment

Next, a mobile communication system according to a third embodiment of the present invention will be explained with reference to FIG. 1 and FIG. 3 to FIG. 5. For clarity, the same components as those in the first embodiment are assigned the same reference numerals and have had their explanations omitted.

The difference between the mobile communication system according to the third embodiment and the first embodiment is that in the third embodiment, when selecting the second frequency (the access frequency) after checking, for example, the frequency band and the frequency number (such as EARFCN) of the selected backhaul radio, the femto cell base station 20 selects a frequency of lowest RSRP (Reference Signal Received Power) (a relatively low RSRP value) around the femto cell base station 20. RSRP represents signal intensity. RSRP changes depending on the distance from surrounding buildings and antennas. So, in this embodiment, for example, the frequency with the lowest RSRP around the femto cell base station 20 is selected.

More specifically, when selecting the second frequency, the femto cell base station 20 according to the third embodiment selects the frequency with the lowest RSRP around the femto cell base station 20. The femto cell base station 20 according to this embodiment is equipped with a control program that performs interference control, control to change an optimum backhaul frequency, control to change the access frequency, and loop prevention control by selecting the frequency with the lowest RSRP around it.

(Interference Control) Referring to FIG. 1, the femto cell base station 20 selects the frequency which makes the second frequency (the access frequency) used for the second radio communication (AC) different from the first frequency (the backhaul frequency) used for the first radio communication (BH) and has the lowest RSRP around the femto cell base station 20. As a result of such selection, it is possible to prevent interference between the backhaul radio and the access radio and effectively improve a radio wave state in the relevant area. The interference control in the mobile communication system according to the third embodiment will be specifically explained below.

The femto cell base station 20 firstly searches around the femto cell base station 20 and then selects a backhaul radio capable of communication depending on its communication capability. After selecting the backhaul radio, the femto cell base station 20 checks, for example, the frequency band and frequency number (such as EARFCN) of the selected backhaul radio.

Next, the femto cell base station 20 automatically selects the frequency, which is different from the selected backhaul frequency and has the lowest RSRP around the femto cell base station 20, as the access frequency.

For example, as illustrated in FIG. 1, when the femto cell base station 20 selects the backhaul radio and then checks the frequency of the selected backhaul radio, the backhaul frequency is Band 1. In this case, Band 1 is excluded from candidates for the access frequency and the frequency with the lowest RSRP around the femto cell base station 20 is automatically selected as the access frequency from among the other candidates, that is, Band 3, Band 8, Band 41, and Band 42.

(Control To Change Optimum Backhaul Frequency) When an optimum macro cell base station 11 is opened in the neighborhood, the femto cell base station 20 also selects the frequency which makes the first frequency (the backhaul frequency) used for the first radio communication (BH) different from the second frequency (the access frequency) used for the second radio communication (AC) and has the lowest RSRP around the femto cell base station 20, thereby preventing interference between the backhaul radio and the access radio. Control to change the optimum BH in the mobile communication system according to the third embodiment will be specifically explained below.

For example, as illustrated in Step (a) of FIG. 3, when the femto cell base station 20 selects the backhaul radio and then checks the frequency of the selected backhaul radio, the backhaul frequency is Band 1. Furthermore, the femto cell base station 20 excludes Band 1 from candidates for the access frequency and automatically selects the frequency Band 41, which is different from the backhaul frequency and has the lowest RSRP around the femto cell base station 20, as the access frequency from among the other candidates, that is, Band 3, Band 8, Band 41, and Band 42.

As an example, a macro cell base station 11 whose backhaul frequency is Band 41 is opened in the neighborhood in this connection status as illustrated in Step (b) of FIG. 3. Even if the macro cell base station 11 of the frequency Band 41 is opened, the femto cell base station 20 and the mobile unit 30 perform access communication using the same frequency Band 41 as that of the opened macro cell base station 11, so that the femto cell base station 20 continues the connection with the macro cell base station 10 with the originally selected frequency Band 1 in order to prevent the backhaul frequency and the access frequency from becoming identical to each other.

Furthermore, that a macro cell base station 12 whose backhaul frequency is Band 3 is opened in the neighborhood as illustrated in Step (c) of FIG. 3. If the femto cell base station 20 determines that the frequency Band 3 is optimum because it is different from the access frequency Band 41 of the mobile unit 30, the femto cell base station 20 switches connection to the macro cell base station 12 with the frequency Band 3.

(Control To Change Access Frequency) When a change instruction to switch the access frequency with the mobile unit 30 is issued from the management server 40, the femto cell base station 20 prevents interference between the backhaul radio and the access radio at the femto cell base station 20 by making the first frequency (the backhaul frequency) used for the first radio communication (BH) different from the second frequency (the access frequency) used for the second radio communication (AC). Control to change the access frequency in the mobile communication system according to the third embodiment will be specifically explained below.

The management server 40 can issue the change instruction to the femto cell base station 20 to switch the access frequency as illustrated in FIG. 4. Even when the management server 40 issues the instruction to the femto cell base station 20 to switch the access frequency, the femto cell base station 20 selects the backhaul frequency so as to make it different from the access frequency.

For example, when the management server 40 issues the change instruction to switch the access frequency of the femto cell base station 20 to Band 1 as illustrated in Step (a) of FIG. 4, the femto cell base station 20 compares the backhaul frequency with the access frequency. Then, the femto cell base station 20 switches the access frequency to Band 1 unless any problem such as interference between the backhaul frequency and the access frequency occurs as a result of the backhaul frequency becoming identical to the access frequency. On the other hand, if any problem such as interference between the backhaul frequency and the access frequency occurs as a result of the backhaul frequency becoming identical to the access frequency, the problem regarding the change instruction is reported to the management server 40. For example, the backhaul frequency is Band 1 as illustrated in Step (a) of FIG. 4. So, if the access frequency is switched to Band 1, the backhaul frequency becomes identical to the access frequency and interference occurs between these frequencies. Then, the femto cell base station 20 reports it to the management server 40 and has it change the backhaul frequency to the frequency Band 41 as illustrated in Step (b) of FIG. 4.

(Loop Prevention Control) The femto cell base station 20 selects the frequency which makes the first frequency (the backhaul frequency) used for the first radio communication (BH) different from the second frequency (the access frequency) used for the second radio communication (AC) and has the lowest RSRP around the femto cell base station 20, thereby preventing the loop phenomenon in which the access radio of the mobile unit 10 can be mistakenly recognized as the backhaul radio. Control to change the access frequency in the mobile communication system according to the third embodiment will be specifically explained below.

When activating the mobile unit 30 as illustrated in Step (a) of FIG. 5, the femto cell base station 20 selects the backhaul radio of the macro cell base station 10, then checks the frequency of the selected backhaul radio, and automatically selects the access frequency which is different from this backhaul frequency and has the lowest RSRP around the femto cell base station 20. Therefore, it is possible to prevent the loop phenomenon in which the access radio can be mistakenly recognized as the backhaul radio.

Even after the activation of the mobile unit 30 as illustrated in Step (b) of FIG. 5, the femto cell base station 20 automatically selects the frequency which has the lowest RSRP around the femto cell base station 20 so as to prevent the backhaul radio of the macro cell base station 10, which performs communication with the same backhaul frequency as the access frequency, from been selected, thereby making it possible to prevent the occurrence of the loop phenomenon.

When the femto cell base station 20 for the mobile communication system according to the third embodiment as explained above selects the second frequency (the access frequency), it selects the frequency with the lowest RSRP around the femto cell base station 20. Therefore, when the mobile communication system according to the third embodiment is employed, it is possible to prevent interference between the backhaul radio and the access radio when starting the connection to the mobile unit 30 and also prevent interference between the backhaul radio and the access radio when changing the backhaul frequency after establishing the connection or when receiving the instruction to change the access frequency. It is also possible to prevent the loop phenomenon of mistakenly recognizing the access radio, which is to communicate with the mobile unit 30, as the backhaul radio by using the mobile communication system 1 according to the third embodiment. Particularly, when the mobile communication system 1 according to the third embodiment is used, the femto cell base station 20 selects the frequency for the lowest RSRP around the femto cell base station 20. So, it has the advantageous effect of being capable of selecting the frequency in a good communication state.

### Fourth Embodiment

Next, a mobile communication system according to a fourth embodiment of the present invention will be explained with reference to FIG. 1 and FIG. 3 to FIG. 5. For clarity the same components as those in the first embodiment are assigned the same reference numerals and have had their explanations omitted.

The difference between the mobile communication system according to the fourth embodiment and the first embodiment is that in the fourth embodiment, when selecting the second frequency (the access frequency) after checking, for example, the frequency band and the frequency number (such as EARFCN) of the selected backhaul radio, the femto cell base station 20 selects a frequency of worst RSRQ (Reference Signal Received Quality) (a relatively low RSRQ value) around it. RSRQ represents signal quality. RSRQ changes depending on the distance from surrounding buildings and antennas. So, in this embodiment, for example, the frequency with the worst RSRQ around the femto cell base station 20 is selected.

More specifically, when selecting the second frequency, the femto cell base station 20 according to the fourth embodiment selects the frequency with the worst RSRQ around the femto cell base station 20. The femto cell base station 20 according to this embodiment is equipped with a control program that performs interference control, control to change an optimum backhaul frequency, control to change the access frequency, and loop prevention control by selecting the frequency with the worst RSRQ around the femto cell base station 20.

(Interference Control) Referring to FIG. 1, the femto cell base station 20 selects the frequency which makes the second frequency (the access frequency) used for the second radio communication (AC) different from the first frequency (the backhaul frequency) used for the first radio communication (BH) and has the worst RSRQ around the femto cell base station 20. As a result of such selection, it is possible to prevent interference between the backhaul radio and the access radio and effectively improve a radio wave state in the relevant area with bad RSRQ. The interference control in the mobile communication system according to the fourth embodiment will be specifically explained below.

The femto cell base station 20 firstly searches around the femto cell base station 20 and then selects backhaul radio capable of communication depending on its communication capability. After selecting the backhaul radio, the femto cell base station 20 checks, for example, the frequency band and frequency number (such as EARFCN) of the selected backhaul radio.

Next, the femto cell base station 20 automatically selects the frequency which is different from the selected backhaul frequency and has the worst RSRQ around the femto cell base station 20.

For example, as illustrated in FIG. 1, when the femto cell base station 20 selects the backhaul radio and then checks the frequency of the selected backhaul radio, the backhaul frequency is Band 1. In this case, Band 1 is excluded from candidates for the access frequency and the frequency with the worst RSRQ around the femto cell base station 20 is automatically selected as the access frequency from among the other candidates, that is, Band 3, Band 8, Band 41, and Band 42.

(Control To Change Optimum Backhaul Frequency) When an optimum macro cell base station 11 is opened in the neighborhood, the femto cell base station 20 also randomly selects the frequency which makes the first frequency (the backhaul frequency) used for the first radio communication (BH) different from the second frequency (the access frequency) used for the second radio communication (AC) and has the worst RSRQ around the femto cell base station 20, thereby preventing interference between the backhaul radio and the access radio. Control to change the optimum BH in the mobile communication system according to the fourth embodiment will be specifically explained below.

For example, as illustrated in Step (a) of FIG. 3, when the femto cell base station 20 selects the backhaul radio and then checks the frequency of the selected backhaul radio, the backhaul frequency is Band 1. Furthermore, the femto cell base station 20 excludes Band 1 from candidates for the access frequency and automatically selects the frequency Band 41, which is different from the backhaul frequency and has the worst RSRQ around the femto cell base station 20, as the access frequency from among the other candidates, that is, Band 3, Band 8, Band 41, and Band 42.

As an example, a macro cell base station 11 whose backhaul frequency is Band 41 is opened in the neighborhood in this connection status as illustrated in Step (b) of FIG. 3. Even if the macro cell base station 11 of the frequency Band 41 is opened, the femto cell base station 20 and the mobile unit 30 perform access communication using the same frequency Band 41 as that of the opened macro cell base station 11, so that the femto cell base station 20 continues the connection with the macro cell base station 10 with the originally selected frequency Band 1 in order to prevent the backhaul frequency and the access frequency from becoming identical to each other.

Furthermore, for example, a macro cell base station 12 whose backhaul frequency is Band 3 is opened in the neighborhood as illustrated in Step (c) of FIG. 3. If the femto cell base station 20 determines that the frequency Band 3 is optimum because it is different from the access frequency Band 41 of the mobile unit 30, the femto cell base station 20 switches connection to the macro cell base station 12 with the frequency Band 3.

(Control To Change Access Frequency) When a change instruction to switch the access frequency is issued from the management server 40, the femto cell base station 20 also prevents interference between the backhaul radio and the access radio by selecting the frequency which makes the first frequency (the backhaul frequency) used for the first radio communication (BH) different from the second frequency (the access frequency) used for the second radio communication (AC) and has the worst RSRQ around it. Control to change the access frequency in the mobile communication system according to the fourth embodiment will be specifically explained below.

The management server 40 can issue the change instruction to the femto cell base station 20 to switch the access frequency as illustrated in FIG. 4. Even when the management server 40 issues the instruction to the femto cell base station 20 to switch the access frequency, the femto cell base station 20 selects the backhaul frequency so as to make it different from the access frequency.

For example, when the management server 40 issues the change instruction to switch the access frequency of the femto cell base station 20 to Band 1 as illustrated in Step (a) of FIG. 4, the femto cell base station 20 compares the backhaul frequency with the access frequency. Then, the femto cell base station 20 switches the access frequency to Band 1 unless any problem such as interference between the backhaul frequency and the access frequency occurs as a result of the backhaul frequency becoming identical to the access frequency. On the other hand, if any problem such as interference between the backhaul frequency and the access frequency occurs as a result of the backhaul frequency becoming identical to the access frequency, the problem regarding the change instruction is reported to the management server 40. For example, the backhaul frequency is Band 1 as illustrated in Step (a) of FIG. 4. So, if the access frequency is switched to Band 1, the backhaul frequency becomes identical to the access frequency and interference occurs between these frequencies. Then, the femto cell base station 20 reports it to the management server 40 and has it change the backhaul frequency to the frequency Band 41 as illustrated in Step (b) of FIG. 4.

(Loop Prevention Control) The femto cell base station 20 selects the frequency which makes the first frequency (the backhaul frequency) used for the first radio communication (BH) different from the second frequency (the access frequency) used for the second radio communication (AC) and has the worst RSRQ around the femto cell base station 20, thereby preventing the loop phenomenon in which the access radio of the mobile unit 10 can be mistakenly recognized as the backhaul radio. Control to change the access frequency in the mobile communication system according to the fourth embodiment will be specifically explained below.

When activating the mobile unit 30 as illustrated in Step (a) of FIG. 5, the femto cell base station 20 selects the backhaul radio of the macro cell base station 10, then checks the frequency of the selected backhaul radio, and automatically selects the access frequency which is different from this backhaul frequency and has the worst RSRQ around the femto cell base station 20. Therefore, it is possible to prevent the loop phenomenon in which the access radio can be mistakenly recognized as the backhaul radio.

Even after the activation of the mobile unit 30 as illustrated in Step (b) of FIG. 5, the femto cell base station 20 automatically selects the frequency which has the worst RSRQ around the femto cell base station 20 so as to prevent the backhaul radio of the macro cell base station 10, which performs communication with the same backhaul frequency as the access frequency, from been selected, thereby making it possible to prevent the occurrence of the loop phenomenon.

When the femto cell base station 20 for the mobile communication system according to the fourth embodiment as explained above selects the second frequency (the access frequency), it selects the frequency with the worst RSRQ around the femto cell base station 20. Therefore, when the mobile communication system according to the fourth embodiment is employed, it is possible to prevent interference between the backhaul radio and the access radio when starting the connection to the mobile unit 30 and also prevent interference between the backhaul radio and the access radio when changing the backhaul frequency after establishing the connection or when receiving the instruction to change the access frequency. It is also possible to prevent the loop phenomenon of mistakenly recognizing the access radio as the backhaul radio by using the mobile communication system according to the fourth embodiment. Particularly, when the mobile communication system according to the fourth embodiment is used, the femto cell base station 20 selects the frequency for the worst RSRQ around the femto cell base station 20. So, it has the advantageous effect of being capable of improving the communication quality of the relevant area.

### Fifth Embodiment

Next, a mobile communication system according to a fifth embodiment of the present invention will be explained with reference to FIG. 1 and FIG. 3 to FIG. 5.For clarity, the same components as those in the first embodiment are assigned the same reference numerals and have had their explanations omitted.

The difference between the mobile communication system according to the fifth embodiment and the first embodiment is that in the fifth embodiment, when selecting the second frequency (the access frequency) after checking, for example, the frequency band and the frequency number (such as EARFCN) of the selected backhaul radio, the femto cell base station 20 selects a frequency outside its range.

More specifically, when selecting the second frequency, the femto cell base station 20 according to the fifth embodiment selects the frequency outside its range. The femto cell base station 20 according to this embodiment is equipped with a control program that performs interference control, control to change an optimum backhaul frequency, control to change the access frequency, and loop prevention control by selecting the frequency outside its range.

(Interference Control) Referring to FIG. 1, the femto cell base station 20 selects the frequency outside its range so as to make the first frequency (the backhaul frequency) used for the first radio communication (BH) different from the second frequency (the access frequency) used for the second radio communication (AC), thereby preventing interference between the backhaul radio and the access radio. The interference control in the mobile communication system according to the fifth embodiment will be specifically explained below.

The femto cell base station 20 firstly searches around the femto cell base station 20 and then selects backhaul radio capable of communication depending on its communication capability. After selecting the backhaul radio, the femto cell base station 20 checks, for example, the frequency band and frequency number (such as EARFCN) of the selected backhaul radio.

Next, the femto cell base station 20 automatically selects the frequency outside its range so as to make the access frequency different from the selected backhaul frequency.

For example, as illustrated in FIG. 1, when the femto cell base station 20 selects the backhaul radio and then checks the frequency of the selected backhaul radio, the backhaul frequency is Band 1. In this case, Band 1 is excluded from candidates for the access frequency and the frequency outside the relevant range is automatically selected as the access frequency from among the other candidates, that is, Band 3, Band 8, Band 41, and Band 42.

(Control To Change Optimum Backhaul Frequency) When an optimum macro cell base station is opened in the neighborhood, the femto cell base station 20 also selects the frequency outside its range so as to make the first frequency (the backhaul frequency) used for the first radio communication (BH) different from the second frequency (the access frequency) used for the second radio communication (AC), thereby preventing interference between the backhaul radio and the access radio. Control to change the optimum BH in the mobile communication system according to the fifth embodiment will be specifically explained below.

For example, as illustrated in Step (a) of FIG. 3, when the femto cell base station 20 selects the backhaul radio and then checks the frequency of the selected backhaul radio, the backhaul frequency is Band 1. Furthermore, the femto cell base station 20 excludes Band 1 from candidates for the access frequency and automatically selects the frequency Band 41 outside its range, which is different from the backhaul frequency, as the access frequency from among the other candidates, that is, Band 3, Band 8, Band 41, and Band 42.

As an example, a macro cell base station 11 whose backhaul frequency is Band 41 is opened in the neighborhood in this connection status as illustrated in Step (b) of FIG. 3. Even if the macro cell base station 11 of the frequency Band 41 is opened, the femto cell base station 20 and the mobile unit 30 perform access communication using the same frequency Band 41 as that of the opened macro cell base station 11, so that the femto cell base station 20 continues the connection with the macro cell base station 10 with the originally selected frequency Band 1 in order to prevent the backhaul frequency and the access frequency from becoming identical to each other.

Furthermore, a macro cell base station 12 whose backhaul frequency is Band 3 is opened in the neighborhood as illustrated in Step (c) of FIG. 3. If the femto cell base station 20 determines that the frequency Band 3 is optimum because it is different from the access frequency Band 41 of the mobile unit 30, the femto cell base station 20 switches connection to the macro cell base station 12 with the frequency Band 3.

(Control To Change Access Frequency) When a change instruction to switch the access frequency is issued from the management server 40, the femto cell base station 20 also prevents interference between the backhaul radio and the access radio by selecting the frequency outside its range so as to make the first frequency (the backhaul frequency) used for the first radio communication (BH) different from the second frequency (the access frequency) used for the second radio communication (AC). Control to change the access frequency in the mobile communication system according to the fifth embodiment will be specifically explained below.

The management server 40 can issue the change instruction to the femto cell base station 20 to switch the access frequency as illustrated in FIG. 4. Even when the management server 40 issues the instruction to the femto cell base station 20 to switch the access frequency, the femto cell base station 20 selects the backhaul frequency so as to make it different from the access frequency.

For example, when the management server 40 issues the change instruction to switch the access frequency of the femto cell base station 20 to Band 1 as illustrated in Step (a) of FIG. 4, the femto cell base station 20 compares the backhaul frequency with the access frequency. Then, the femto cell base station 20 switches the access frequency to Band 1 unless any problem such as interference between the backhaul frequency and the access frequency occurs as a result of the backhaul frequency becoming identical to the access frequency. On the other hand, if any problem such as interference between the backhaul frequency and the access frequency occurs as a result of the backhaul frequency becoming identical to the access frequency regarding which the change instruction was issued, the problem regarding the change instruction is reported to the management server 40. For example, the backhaul frequency is Band 1 as illustrated in Step (a) of FIG. 4. So, if the access frequency is switched to Band 1, the backhaul frequency becomes identical to the access frequency and interference occurs between these frequencies. Then, the femto cell base station 20 reports it to the management server 40 and has it change the backhaul frequency to the frequency Band 41 as illustrated in Step (b) of FIG. 4.

(Loop Prevention Control) The femto cell base station 20 selects the frequency outside its range so as to make the first frequency (the backhaul frequency) used for the first radio communication (BH) different from the second frequency (the access frequency) used for the second radio communication (AC), thereby preventing the loop phenomenon in which the access radio of the mobile unit 10 can be mistakenly recognized as the backhaul radio. Control to change the access frequency in the mobile communication system according to the fifth embodiment will be specifically explained below.

When activating the mobile unit 30 as illustrated in Step (a) of FIG. 5, the femto cell base station 20 selects the backhaul radio of the macro cell base station 10, then checks the frequency of the selected backhaul radio, and selects the frequency which is different from this backhaul frequency and is outside its range. Therefore, it is possible to prevent the loop phenomenon in which the access radio can be mistakenly recognized as the backhaul radio. Even after the activation of the mobile unit 30 as illustrated in Step (b) of FIG. 5, the femto cell base station 20 automatically selects the frequency outside its range so as to prevent the backhaul radio of the macro cell base station 10, which performs communication with the same backhaul frequency as the access frequency, from been selected, thereby making it possible to prevent the occurrence of the loop phenomenon.

When the femto cell base station 20 for the mobile communication system according to the fifth embodiment as explained above selects the second frequency (the access frequency), it selects the frequency outside its range. Therefore, when the mobile communication system according to the fifth embodiment is employed, it is possible to prevent interference between the backhaul radio and the access radio when starting the connection to the mobile unit 30 and also prevent interference between the backhaul radio and the access radio when changing the backhaul frequency after establishing the connection or when receiving the instruction to change the access frequency. It is also possible to prevent the loop phenomenon of mistakenly recognizing the access radio as the backhaul radio by using the mobile communication system 1 according to the fifth embodiment. Particularly, when the mobile communication system 1 according to the fifth embodiment is used, the frequency outside its range is selected. So, it has the advantageous effect of making interference hardly occur between the frequencies.

### Sixth Embodiment

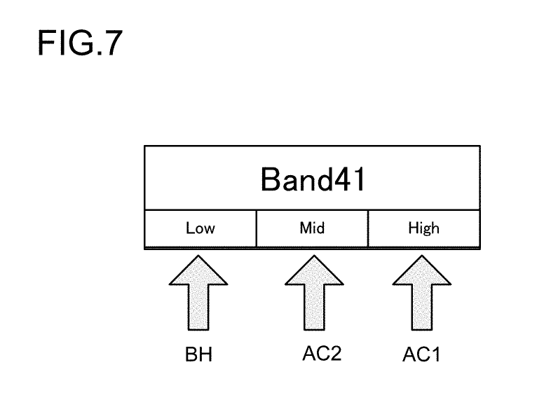

Next, a mobile communication system according to a sixth embodiment of the present invention will be explained with reference to FIG. 1, FIG. 3 to FIG. 5, and FIG. 7. For clarity, the same components as those in the first embodiment are assigned the same reference numerals and have had their explanations omitted.

Among frequency bands allocated to carriers, there are frequency bands which are relatively wide and regarding which a plurality of frequencies can be selected in the same frequency band. FIG. 7 indicates Band 41 as an example of such a wide-bandwidth frequency band. Regarding the frequency band Band41 as illustrated in FIG. 7, a frequency Low that is relatively low, a frequency High that is relatively high, and a frequency Mid between the frequencies Low and High, which are in the same frequency bandwidth and do not interfere with each other can be selected. The difference between this sixth embodiment and the first embodiment is that in this sixth embodiment, the first frequency relating to the backhaul radio and the second frequency relating to the access radio are different frequencies within the same frequency band and the femto cell base station 20 operates to select a frequency which is adjacent to a previously selected frequency and is a different frequency in the same frequency band, so as to make the first frequency and the second frequency different from each other. Under this circumstance, the farthest possible frequency within the selectable frequencies is prioritized in selection of the adjacent frequency; and a more adjacent frequency has lower priority. An adjacent frequency is selected in an unavoidable case, for example, where electric field intensity of a far frequency radiated by another femto cell base station 20 is high.

More specifically, when selecting at least one of the first frequency and the second frequency from the same frequency band Band 41 as illustrated in FIG. 7, the femto cell base station 20 according to the sixth embodiment selects a frequency which is adjacent to a previously selected frequency and is a different frequency in the same frequency band. The femto cell base station 20 according to this embodiment is equipped with a control program that performs interference control, control to change the optimum backhaul frequency, control to change the access frequency, and loop prevention control by selecting the adjacent frequencies in the same frequency band.

(Interference Control) Referring to FIG. 1, the femto cell base station 20 selects an adjacent frequency in the same frequency as that of a previously selected frequency so as to make the first frequency (the backhaul frequency) used for the first radio communication (BH) different from the second frequency (the access frequency) used for the second radio communication (AC), thereby preventing interference between the backhaul radio and the access radio. The interference control in the mobile communication system according to the sixth embodiment will be specifically explained below.

The femto cell base station 20 firstly searches around the femto cell base station 20 and then selects backhaul radio capable of communication depending on its communication capability. After selecting the backhaul radio, the femto cell base station 20 checks, for example, the frequency band and frequency number (such as EARFCN) of the selected backhaul radio.

Next, the femto cell base station 20 automatically selects the frequency, which is different from the selected backhaul frequency and is an adjacent frequency in the same frequency band as that of the backhaul frequency, as the access frequency.

For example, as illustrated in FIG. 7, when the femto cell base station 20 selects the backhaul radio and then checks the frequency of the selected backhaul radio, the backhaul frequency is Low in Band 41. In this case, the frequency High which is in the same Band 41 as the frequency Low and is farthest possible from the frequency Low is automatically selected as an access frequency AC1 of first priority from among candidates for the access frequency. If any inconvenience happens with respect to the selection of the access frequency AC1, the frequency Mid which is closer to the backhaul frequency Low is automatically selected as an access frequency AC2 of second priority.

(Control To Change Optimum Backhaul Frequency) When an optimum macro cell base station 11 is opened in the neighborhood, the femto cell base station 20 also selects a frequency which is adjacent to a previously selected frequency and is a different frequency in the same frequency band, or another frequency band which will not cause interference, so as to make the first frequency (the backhaul frequency) used for the first radio communication (BH) different from the second frequency (the access frequency) used for the second radio communication (AC), thereby preventing interference between the backhaul radio and the access radio. Control to change the optimum BH in the mobile communication system according to the sixth embodiment will be specifically explained below.

For example, as illustrated in FIG. 7, when the femto cell base station 20 selects the backhaul radio and then checks the frequency of the selected backhaul radio, the backhaul frequency is Low in Band 41. Furthermore, the femto cell base station 20 automatically selects the adjacent frequency High in Band 41 as the access frequency AC1 from among the candidates for the access frequency.

As an example, a macro cell base station 11 whose backhaul frequency is High in Band 41 is opened in the neighborhood in this connection status. Even if the macro cell base station 11 with the frequency Band 41 High is opened, the femto cell base station 20 and the mobile unit 30 perform access communication using the same frequency Band 41 High as that of the opened macro cell base station 11, so that the femto cell base station 20 continues the connection with the macro cell base station 10 with the originally selected frequency Low in Band 41 in order to prevent the backhaul frequency and the access frequency from becoming identical to each other.

Meanwhile, for example, a macro cell base station 12 whose backhaul frequency is Mid in Band 41 is opened in the neighborhood. If the femto cell base station 20 determines that the frequency Mid in Band 41 is optimum because it is different from the access frequency Band 41 High of the mobile unit 30, the femto cell base station 20 switches connection to the macro cell base station 12 with the frequency Mid in Band 41.

(Control To Change Access Frequency) When a change instruction to switch the access frequency with the mobile unit 30 is issued from the management server 40, the femto cell base station 20 prevents interference between the backhaul radio and the access radio by selecting the frequency which is adjacent to the previously selected frequency and is a different frequency in the same frequency band so as to make the first frequency (the backhaul frequency) used for the first radio communication (BH) different from the second frequency (the access frequency) used for the second radio communication (AC). Control to change the access frequency in the mobile communication system according to the sixth embodiment will be specifically explained below.

The management server 40 can issue the change instruction to the femto cell base station 20 to switch the access frequency as illustrated in FIG. 4. Even when the management server 40 issues the instruction to the femto cell base station 20 to switch the access frequency, the femto cell base station 20 selects the frequency which is a different frequency in the same frequency band as the access frequency, or another frequency band which will not cause interference, as the backhaul frequency so as to make it different from the access frequency.

For example, when the management server 40 issues the change instruction to switch the access frequency of the femto cell base station 20 to High in Band 41 as illustrated in FIG. 7, the femto cell base station 20 compares the backhaul frequency with the access frequency. Then, the femto cell base station 20 switches the access frequency to High in Band 41 unless any problem such as interference between the backhaul frequency and the access frequency occurs as a result of the backhaul frequency becoming identical to the access frequency. On the other hand, if any problem such as interference between the backhaul frequency and the access frequency occurs as a result of the backhaul frequency becoming identical to the access frequency regarding which the change instruction was issued, the problem regarding the change instruction is reported to the management server 40. For example, if the backhaul frequency is High in Band 41 which is the same as the access frequency, the backhaul frequency becomes identical to the access frequency and interference occurs between these frequencies. Then, the femto cell base station 20 reports it to the management server 40 and switches the access frequency to Low or Mid in Band 41 or to another frequency band which will not cause interference.

(Loop Prevention Control) The femto cell base station 20 selects the frequency which is adjacent to the previously selected frequency and is a different frequency in the same frequency band so as to make the first frequency (the backhaul frequency) used for the first radio communication (BH) different from the second frequency (the access frequency) used for the second radio communication (AC), thereby preventing the loop phenomenon in which the access radio of the mobile unit 10 can be mistakenly recognized as the backhaul radio. Control to change the access frequency in the mobile communication system according to the sixth embodiment will be specifically explained below.

When activating the mobile unit 30 as illustrated in Step (a) of FIG. 5, the femto cell base station 20 selects the backhaul radio of the macro cell base station 10, then checks the frequency of the selected backhaul radio, and selects the frequency which is adjacent to the previously selected frequency and is a different frequency in the same frequency band so as to make the frequency different from this backhaul frequency. Therefore, it is possible to prevent the loop phenomenon in which the access radio can be mistakenly recognized as the backhaul radio.

Even after the activation of the mobile unit 30 as illustrated in Step (b) of FIG. 5, the femto cell base station 20 automatically selects the frequency which is adjacent to the same frequency as the access frequency and is a different frequency in the same frequency band so as to prevent the backhaul radio of the macro cell base station 10, which performs communication with the same backhaul frequency as the access frequency, from been selected, thereby making it possible to prevent the occurrence of the loop phenomenon.

When the femto cell base station 20 for the mobile communication system according to the sixth embodiment as explained above selects at least one of the first frequency (the backhaul frequency) and the second frequency (the access frequency), it selects the frequency which is adjacent to the previously selected frequency and is a different frequency in the same frequency band. The farthest possible frequency within the selectable frequencies in the same frequency band is prioritized in selection of the adjacent frequency; and a more adjacent frequency has lower priority. An adjacent frequency is selected in an unavoidable case, for example, where electric field intensity of a far frequency radiated by another femto cell base station 20 is high. Therefore, when the mobile communication system according to the sixth embodiment is employed, it is possible to prevent interference between the backhaul radio and the access radio when activating the mobile unit 30 and also prevent interference between the backhaul radio and the access radio when changing the backhaul frequency after establishing the connection or when receiving the instruction to change the access frequency. It is also possible to prevent the loop phenomenon of mistakenly recognizing the access frequency as the backhaul frequency by using the mobile communication system according to the sixth embodiment. Particularly, when the mobile communication system according to the sixth embodiment is used, the femto cell base station 20 selects the adjacent frequency in the same frequency band as that of the previously selected frequency. So, it has the advantageous effect of being capable of easily preventing interference between the frequencies.

[Other Embodiments] The present invention has been described by referring to the embodiments as described above; however, it should not be understood that the descriptions and diagrams which constitute part of this disclosure limit this invention. This disclosure should make various substitute embodiments, examples, and operation technologies apparent to those skilled in the art.

For example, the present invention includes a mobile communication method or mobile communication program for relaying packet communication between a macro cell base station and a mobile unit, wherein the mobile communication method or mobile communication program includes: a function that executes first radio communication with the macro cell base station; a function that executes second radio communication with the mobile unit; and a function that automatically selects at least one of a first frequency used for the first radio communication and a second frequency used for the second radio communication so as to make the first frequency and the second frequency different from each other. The present invention can be configured so that a sole femto cell base station can execute the above-described functions or so that the femto cell base station, the macro cell base station, and any other devices can cooperate with each other to execute the above-described functions.

Furthermore, for example, the femto cell base station in the aforementioned embodiments has been described by taking an integrated base station, in which the base station control unit and the radio unit are integrated with each other, as an example. However, the femto cell base station can be a separated base station in which the base station control unit and the radio unit are separated from each other. Accordingly, it should be understood that the present invention includes various embodiments which are not described here.

### REFERENCE SIGNS LIST

1: Mobile communication system; 10: macro cell base station; 20: femto cell base station; 30: mobile unit; and 40: management server.

What is claimed is:

1. A mobile communication system for relaying packet communication between a macro cell base station and a mobile unit,
the mobile communication system comprising a femto cell base station including:
a base station control unit configured to execute a first radio communication with the macro cell base station;
and a radio unit configured to execute a second radio communication with the mobile unit,
wherein at least one of a first frequency used for the first radio communication and a second frequency used for the second radio communication is automatically selected to make the first frequency and the second frequency different from each other.

2. The mobile communication system according to claim 1, wherein the femto cell base station is configured to randomly select a frequency to make the first frequency and the second frequency different from each other.

3. The mobile communication system according to claim 1, wherein the femto cell base station is configured to select a frequency according to a predefined combination of frequencies to make the first frequency and the second frequency different from each other.

4. The mobile communication system according to claim 1, wherein the femto cell base station is configured to select a frequency of weakest signal intensity around the femto cell base station to make the first frequency and the second frequency different from each other.

5. The mobile communication system according to claim 1, wherein the femto cell base station is configured to select a frequency of worst signal quality around the femto cell base station to make the first frequency and the second frequency different from each other.

6. The mobile communication system according to claim 1, wherein the femto cell base station is configured to select a frequency outside its range to make the first frequency and the second frequency different from each other.

7. The mobile communication system according to claim 1, wherein the femto cell base station is configured to select a frequency adjacent to a previously selected frequency and is a different frequency within the same frequency band to make the first frequency and the second frequency different from each other, with the first frequency and the second frequency as different frequencies within the same frequency band.

8. The mobile communication system according to claim 1, wherein the femto cell base station is a separated base station, in which the base station control unit and the radio unit are separated from each other, or an integrated base station, in which the base station control unit and the radio unit are integrated with each other.
